(19) United States
(12) Patent Application Publication
(10) Pub. No.: US 2022/0250378 A1
(43) Pub. Date: Aug. 11, 2022

(54) MULTI-MODE FLUID EJECTION DIE

(71) Applicant: Hewlett-Packard Development Company, L.P., Spring, TX (US)

(72) Inventors: Eric T. Martin, Corvallis, OR (US); Tsuyoshi Yamashita, Corvallis, OR (US)

(73) Assignee: Hewlett-Packard Development Company, L.P., Spring, TX (US)

(21) Appl. No.: 17/414,426

(22) PCT Filed: Jul. 12, 2019
(86) PCT No.: PCT/US2019/041619

§ 371 Date: Jun. 16, 2021

(51) Int. Cl. B41J 2/045

(52) U.S. Cl. CPC B41J 2/04541; B41J 2/0458; B41J 2/04581

(57) ABSTRACT

In various examples, a fluid ejection die may include an addressing circuit to selectively activate a primitive having a plurality of fluid ejection nozzles in either a first mode or a second mode based on control data received from a fluid ejection system. In the first mode, the addressing circuit may selectively activate, based on the control data, each of the plurality of fluid ejection nozzles during a respective time slice of a first print period. In the second mode, the addressing circuit may selectively activate, based on the control data, each of a plurality of subsets of nozzles of the plurality of fluid ejection nozzles during a respective time slice of a second print period. Moreover, in some examples, the second print period may be a fraction of the first print period.

### BACKGROUND

Many fluid ejection systems, such as ink jet printers, include fluid ejection devices, such as printheads, which may or may not be replaceable (alone or in combination with other fluid ejection components). Some fluid ejection devices may include fluid ejection die(s). In some cases, these fluid ejection die(s) may include addressing circuitry that allows fluids, such as ink, to be selectively ejected at desired locations on a print medium through a plurality of nozzles of the fluid ejection die. Once installed in a fluid ejection system, electrical signals received at the fluid ejection device from the fluid ejection system may be processed by the addressing circuitry of the fluid ejection die to control which of the plurality of nozzles are activated (“fired”) and/or a time and/or sequence for when each of the plurality of nozzles are to be activated.

### BRIEF DESCRIPTION OF THE DRAWINGS

Features of the present disclosure are illustrated by way of example and not limited in the following figure(s), in which like numerals indicate like elements.

FIG. 1 is a drawing of an example printing press that uses fluid ejection devices such as printheads to eject various fluids on a print medium.

FIG. 2 is a block diagram of an example of a fluid ejection system that may be used to eject various fluids onto a medium.

FIG. 3 is a drawing of a cluster of ink jet printheads in an example print configuration, for example, in a printbar.

FIGS. 4A and 4B are drawings of example fluid ejection dies configured for multi-mode activation.

FIG. 5 is a block diagram of an example of drive circuitry that can be used to control fluid ejection dies.

FIGS. 6A and 6B are schematic diagrams showing an example of an addressing circuit that can implement multi-mode activation of fluid ejection dies.

FIG. 7 is a simplified block diagram showing an example of a printhead assembly that supports multi-mode activation of fluid ejection dies.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Additionally, it should be understood that the elements depicted in the accompanying figures may include additional components and that some of the components described in those figures may be removed and/or modified without departing from the scope of the elements disclosed herein. It should also be understood that the elements depicted in the figures may not be drawn to scale and thus, the elements may have different sizes and/or configurations other than as shown in the figures.

Techniques described herein relate to increasing fluid ejection speeds and/or increasing nozzle firing rates, and thus, print speed in many examples, by alternating between modes in which individual fluid ejection nozzles, or subsets (e.g., pairs) of fluid ejection nozzles, are activated based on a single fluid ejection command. In some examples, when the priority is print speed over quality, subsets of m fluid ejection nozzles (e.g., pairs, triplets, or subsets of other sizes), which may or may not be adjacent each other, may be activated simultaneously to facilitate higher speed printing. When the priority is print quality over print speed, on the other hand, fluid ejection nozzles can be activated on an individual basis.

In various examples, the plurality of nozzles of a fluid ejection die may be organized into logical groups of N (N being a positive integer) nozzles referred to herein as “fluid ejection primitives,” or simply, “primitives.” “Primitives” are so-named because they may constitute the smallest, or most atomic, component that can be individually addressed, e.g., by a printing system, with what will be referred to herein as “primitive fluid ejection commands.” A “primitive fluid ejection command” is data that, while being addressed to a fluid ejection primitive as a whole, is interpreted to selectively fire (or not fire) individual nozzles of the primitive. Put another way, although individual nozzle(s) of a primitive may be selectively fired using a primitive fluid ejection command, the primitive fluid ejection command is addressed to the primitive as a whole, rather than to individual nozzles. For example, a single primitive fluid ejection command addressed to a primitive may, depending on a selected printing mode (described below), cause either a single nozzle of the primitive to fire, or multiple nozzles of the primitive to fire.

As used herein, a “time slice” is a time interval of a print job during which a single primitive fluid ejection command is sent to a primitive. If there are multiple primitives on a fluid ejection die, then a time slice constitutes a time period during which a single primitive fluid ejection command is sent to each of the multiple primitives. Thus, if there are four primitives on a given fluid ejection die, then four primitive fluid ejection commands may be sent (e.g., simultaneously) to the die during a given time slice, one command for each primitive.

As mentioned previously, a fluid ejection die may be capable of being operated in multiple different print modes, such as a high quality mode and a high speed mode. While in the high quality mode, if it is desired to activate all N fluid ejection nozzles of a given primitive, then N distinct primitive fluid ejection commands may be sent to the fluid ejection die over N time slices. Each distinct primitive fluid ejection command causes a single nozzle of the primitive to be fired.

For example, if the given primitive includes, for example, eight fluid ejection nozzles, then eight primitive fluid ejection commands can be sent to the fluid ejection die over eight time slices to activate the eight fluid ejection nozzles of the primitive. The eight respective time slices to activate each of the eight individually-controllable fluid ejection nozzles collectively add up to what will be referred to herein as a “print period.” Put another way, a “print period” is an amount of time used to fire all eight (or more generally, N) nozzles of the primitive in the high quality mode. Therefore, in the high quality mode for this example, the print period to activate each of the eight individually-controllable fluid ejection nozzles is comprised of eight time slices.

By contrast, while in the high speed mode, it is possible to fire all N nozzles of the primitive in fewer time slices—and hence, in a fraction of the print period described above. In particular, in the high speed mode, multiple fluid ejection nozzles of the primitive—also referred to herein as “subsets” of m fluid ejection nozzles, m being a positive integer less than N—are fired at once. Consequently, if it is desired to activate all N fluid ejection nozzles of a given primitive, then N/m distinct primitive fluid ejection commands may be sent to the fluid ejection die over N/m time slices.

As an example, if the primitive includes eight fluid ejection nozzles and pairs of adjacent nozzles are simultaneously activated in the high speed mode, then m may be equal to two. As another example, if the primitive includes nine fluid ejection nozzles and triplets of adjacent nozzles are simultaneously activated in the high speed mode, then m may be equal to three, and so on. Put another way, techniques described herein facilitate selective activation of all nozzles of a primitive individually during a print period in a high quality mode, or selective activation of all nozzles of the primitive via subsets of the nozzles during a fraction of the print period in a high speed mode.

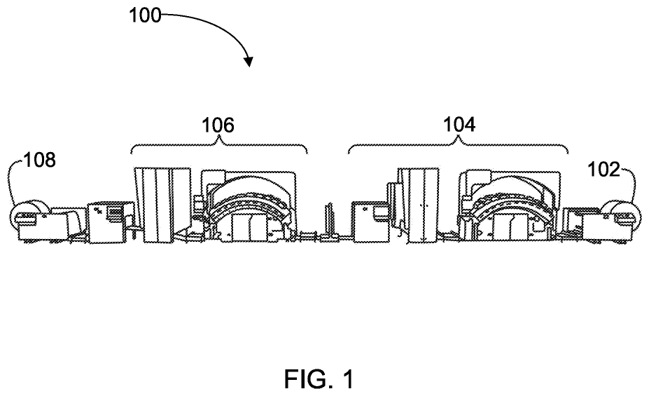

Referring now to the drawings, FIG. 1 is a drawing of a non-limiting example of a printing press 100 that uses ink jet printheads to eject various fluids (e.g., ink) on a print medium. The printing press 100 can feed a continuous sheet of a print medium from a large roll 102. The print medium can be fed through a number of printing systems, such as first printing system 104. In the first printing system 104, a printbar that houses a number of printheads can eject ink droplets onto the print medium. A second printing system 106 may additionally and/or alternatively be used to print additional colors. For example, the first printing system 104 may print black, while the second printing system 106 may print cyan, magenta, and yellow (CMY).

The printing systems 104 and 106 are not limited to two, or the mentioned color combinations, as any number of systems may be used, depending, for example, on the colors desired and the speed of the printing press 100. Moreover, techniques described herein are not limited to printing presses such as that depicted in FIG. 1. Techniques described herein can be implemented in a wide variety of scenarios, such as in desktop printers, end-of-aisle printers, a printhead with a single die, thermal ink jet printers, piezoelectric ink jet printers, etc. Further, techniques described herein may apply to systems with a fixed printhead and/or printbar and moving media, and/or to systems with scanning printheads and/or bars. In addition, techniques described herein are applicable with both two-dimensional (“2D”) and three-dimensional (“3D”) printers (e.g., additive manufacturing), and other fluid ejection devices, such as life sciences or other micro-fluidic applications.

After the second printing system 106, the printed print medium may be taken up on a take-up roll 108 for later processing. In some examples, other units may replace the take-up roll 108, such as a sheet cutter and binder, among others. The printing press 100 can feed the print medium from the large roll 102 to the printing systems 104 and 106 and to the take-up roll 108 at different rates depending on a mode of operation of the printing press 100. For example, if the printing press 100 is operating in a high speed mode, then the print medium can be fed at a faster rate as compared to, for example, when the printing press 100 is operating in a high quality mode. The printing press 100 of FIG. 1 is provided as a non-limiting example. Other fluid ejection systems are contemplated herein.

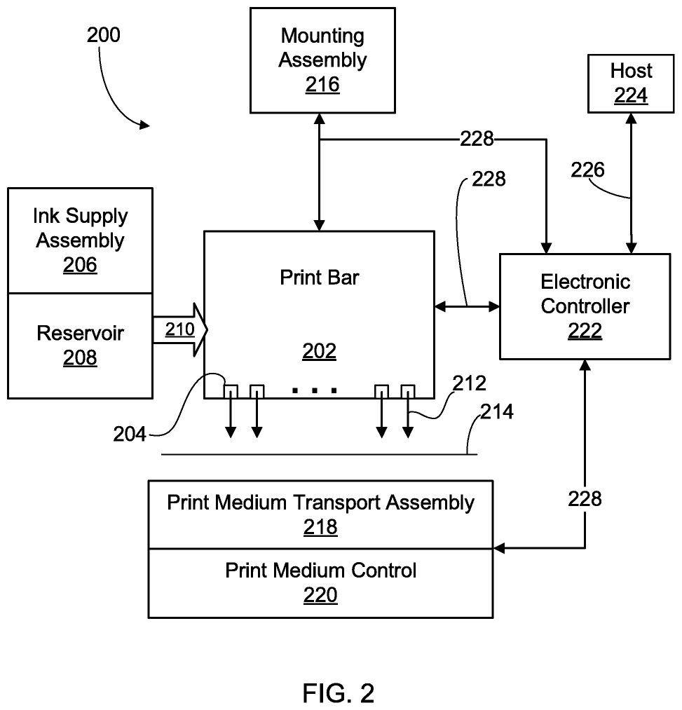

FIG. 2 is a block diagram of an example of an ink jet printing system 200 that may be used to eject various fluids (e.g., ink) using ink jet printheads. The ink jet printing system 200 includes a printbar 202, which includes a number of printheads 204, and an ink supply assembly 206. The ink supply assembly 206 includes an ink reservoir 208. From the ink reservoir 208, ink 210 is provided to the printbar 202 to be fed to the printheads 204. The ink supply assembly 206 and printbar 202 may use a one-way ink delivery system or a recirculating ink delivery system. In a one-way ink delivery system, substantially all of the ink supplied to the printbar 202 is consumed during printing. In a recirculating ink delivery system, a portion of the ink 210 supplied to the printbar 202 is consumed during printing, and another portion of the ink is returned to the ink supply assembly 206. In an example, the ink supply assembly 206 is separate from the printbar 202, and supplies the ink 210 to the printbar 202 through a tubular connection, such as a supply tube (not shown). In other examples, the printbar 202 may include the ink supply assembly 206, and the ink reservoir 208, along with the printhead 204, for example, in single user printers. In either example, the ink reservoir 208 of the ink supply assembly 206 may be removed and replaced, or refilled.

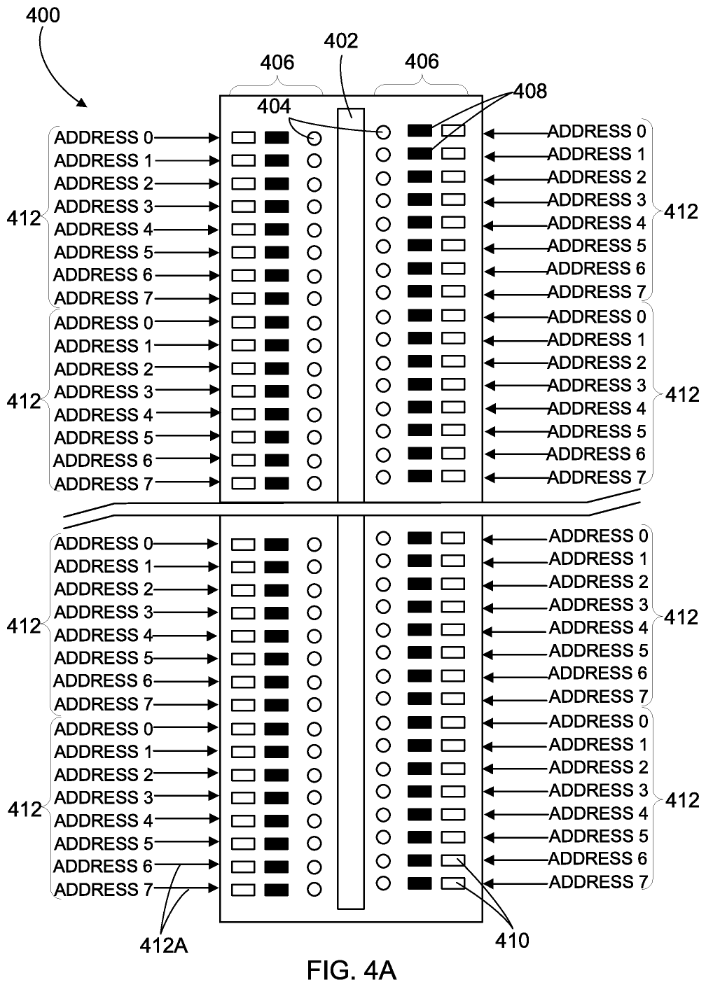

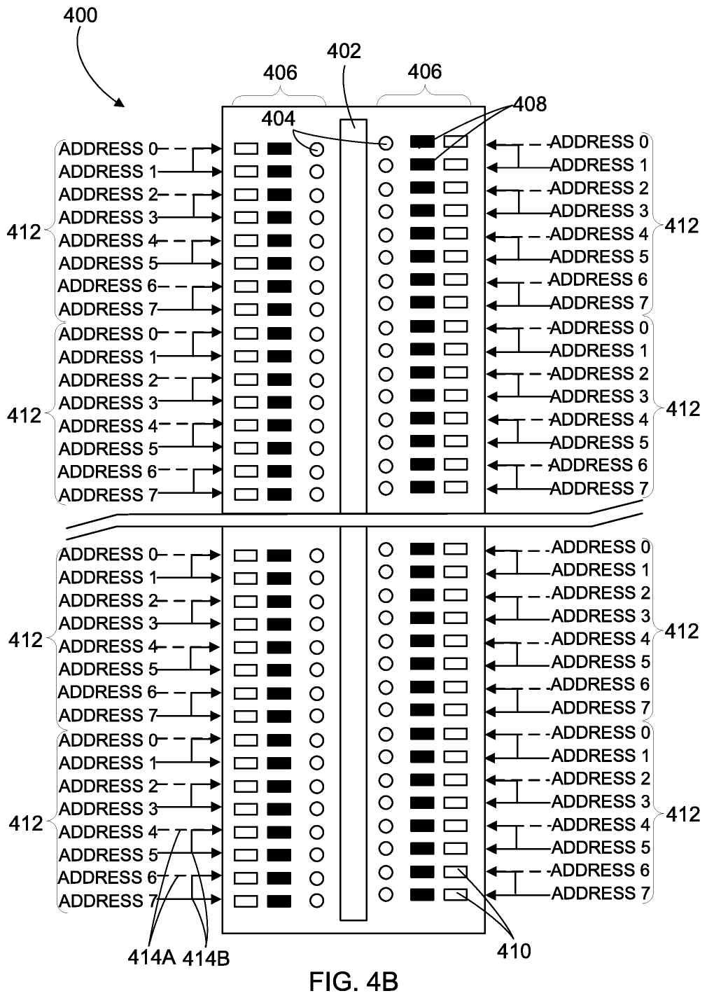

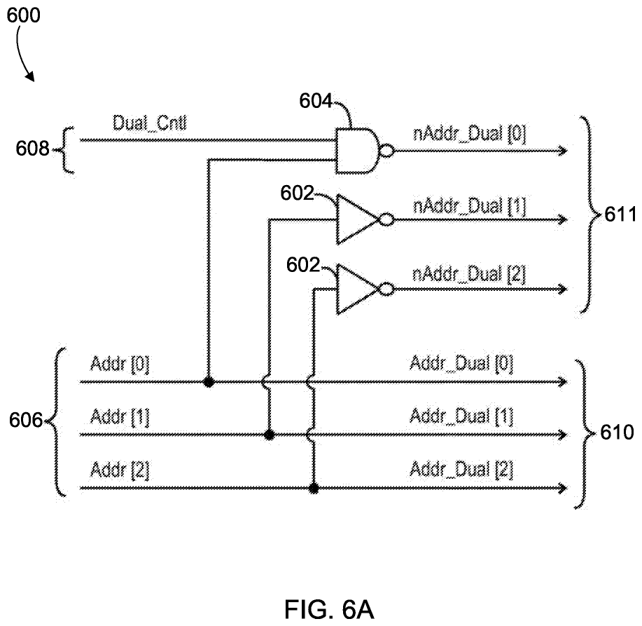

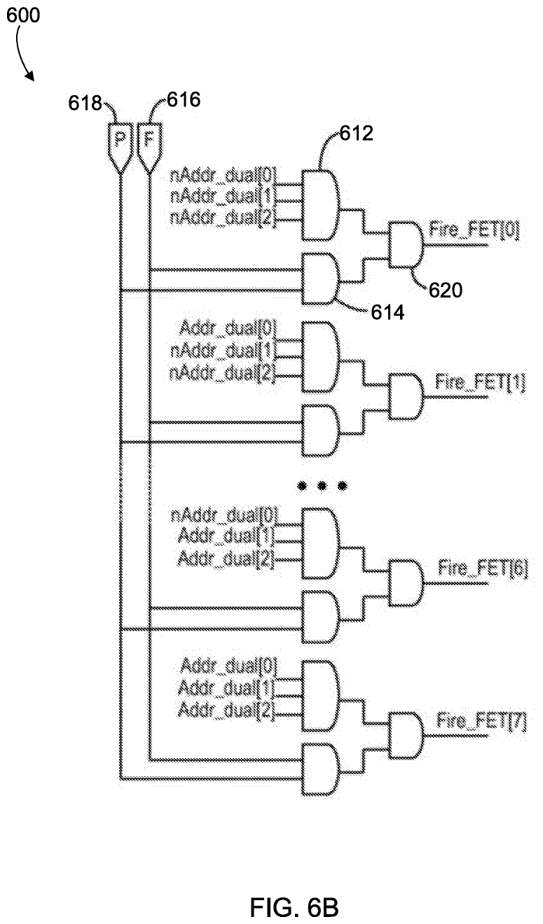

From the printheads 204, the ink 210 is ejected (“fired”) from nozzles as ink droplets 212 towards a print medium 214, such as paper, Mylar, cardstock, and the like. The nozzles of the printheads 204 are arranged in columns or arrays such that properly sequenced ejection of ink 210 can form characters, symbols, graphics, or other images to be printed on the print medium 214 as the printbar 202 and print medium 214 are moved relative to each other. Various configurations of nozzles (e.g., with respect to FIGS. 4A and 4B) and firing of the nozzles (e.g., with respect to FIGS. 6A and 6B) is disclosed in more detail herein. The ink 210 is not limited to colored liquids used to form visible images on a print medium, for example, the ink 210 may be an electro-active substance used to print circuit patterns, such as solar cells. The ink 210 may also be materials for 3D printing, such as Acrylonitrile Butadiene Styrene (“ABS”) plastic, Polylactic acid (“PLA”), Polyethylene Terephthalate (“PET”), Polyamides (such as nylon), Polycarbonate (“PC”), or any other suitable fluid.

A mounting assembly 216 may be used to position the printbar 202 relative to the print medium 214. In an example, the mounting assembly 216 may be in a fixed position, holding a number of printheads 204 above the print medium 214. In another example, the mounting assembly 216 may include a motor that moves the printbar 202 back and forth across the print medium 214, for example, if the printbar 202 included a plurality of printheads 204 (e.g., such as the four printheads 204 illustrated in FIG. 2). A print medium transport assembly 218 moves the print medium 214 relative to the printbar 202, for example, moving the print medium 214 perpendicular to the printbar 202. In the example of FIG. 1, the print medium transport assembly 218 may include the rolls 102 and 108, as well as any number of motorized pinch rolls used to pull the print medium through the printing systems 104 and 106. If the printbar 202 is moved, the print medium transport assembly 218 may index the print medium 214 to new positions. In examples in which the printbar 202 is not moved, the motion of the print medium 214 may be continuous.

The print medium transport assembly 218 can also include print medium control 220. The print medium control 220 can control a rate the print medium 214 is fed across the printbar 202. The rate the print medium 214 is fed across the printbar 202 may depend on a mode of operation for the ink jet printing system 200. For example, in a first mode, such as a high speed mode, the print medium 214 can be fed across the printbar 202 (more particularly, the printheads 204) at a first rate (e.g., 60 pages per minute). In contrast, in a second mode, such as a high quality mode, the print medium 214 can be fed across the printbar 202 at a second rate (e.g., 30 pages per minute). As a result of these varying rates, and as described in more detail herein (e.g., with respect to FIGS. 4A-6B), the printheads 204 can also fire differently based on these different modes.

An electronic controller 222 receives data from a host system 224, such as a computer. The data may be transmitted over a network connection 226, which may be an electrical connection, an optical fiber connection, or a wireless connection, among others. The data may include a document or file to be printed, or may include more elemental items, such as a color plane of a document or a rasterized document. The electronic controller 222 may temporarily store the data in a local memory for analysis. The analysis may include determining timing and/or sequence control for the ejection of ink drops from the printheads 204, as well as the motion of the print medium 214 (e.g., a rate of speed for displacing the print media 214 via the print medium transport assembly 218) and any motion of the printbar 202. Further, the electronic controller 222 may take various forms, such as a field-programmable gate array (“FPGA”), an application-specific integrated circuit “(ASIC”), or a processor that executes instructions stored in memory.

The electronic controller 222 may operate the individual parts of the printing system over control lines 228. For example, the electronic controller 222 can send data to the printheads 204 via control lines 228. The data can be processed at each of the printheads 204 by addressing circuitry (e.g., 600 in FIGS. 6A and 6B) disposed on or embedded in the printheads 204. The processed data can be used to determine which nozzles on each of the printheads 204 are to be activated (“fired”) and when the printheads 204 are to be activated. Further, the processed data can be used to determine a mode of operation (e.g., high speed mode or high quality mode) for the printheads 204. Accordingly, the electronic controller 222 defines a pattern of ejected ink droplets 212 which form characters, symbols, graphics, or other images on the print medium 214.

The ink jet printing system 200 is not limited to the items shown in FIG. 2. For example, the electronic controller 222 may be a cluster computing system coupled in a network that has separate computing controls for individual parts of the system. For example, a separate controller may be associated with each of the mounting assembly 216, the printbar 202, the ink supply assembly 206, and the print medium transport assembly 218. In this example, the control lines 228 may be network connections coupling the separate controllers into a single network. In other example, the mounting assembly 216 may not be a separate item from the printbar 202, for example, if no motion is needed by the printbar 202.

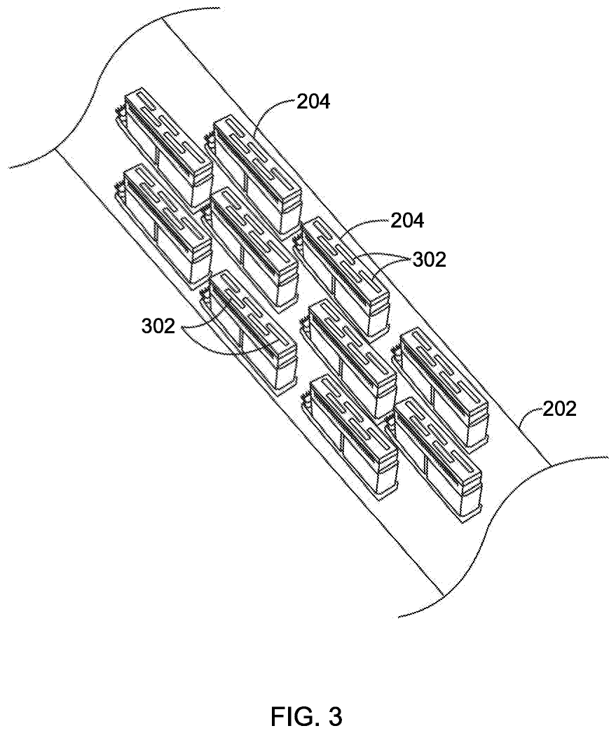

FIG. 3 is a drawing of a cluster of ink jet printheads 204 in an example print configuration, for example, in a printbar 202. Like numbered items are as described with respect to FIG. 2. The printbar 202 shown in FIG. 3 may be used in configurations that do not move the printhead. Accordingly, the printheads 204 may be attached to the printbar 202 in an overlapping configuration to give complete coverage of the print medium 214. In this example, each of the printheads 204 have multiple fluid ejection dies 302 (also referred to as “dice”) that have the nozzles and circuitry used to eject ink droplets. In various examples, the fluid ejection die 302 may or may not be constructed with materials such as silicon. The addressing circuitry (e.g., 600 in FIGS. 6A and 6B) described herein may be disposed (e.g., embedded in), among other places, on these individual fluid ejection dies 302.

FIGS. 4A and 4B are drawings of example fluid ejection dies (or “dice”) 400 configured for multi-mode activation of the fluid ejection dies 400. Each fluid ejection die 400 includes an ink feed slot 402 (e.g., connected the ink supply assembly 206 using a supply tube) that in some cases may be an array of ink feed holes. Further, each fluid ejection die 400 can include two columns of fluid ejection nozzles 404 (referred to herein as “nozzles 404”), where each column can be a two-dimensional array of nozzles. Each side of the ink feed slot 402 may be referred to as a nozzle column 406. During use, ink is drawn from the ink feed slot 402 and ejected from the nozzles 404 onto a print medium (e.g., print medium 214 of FIG. 2).

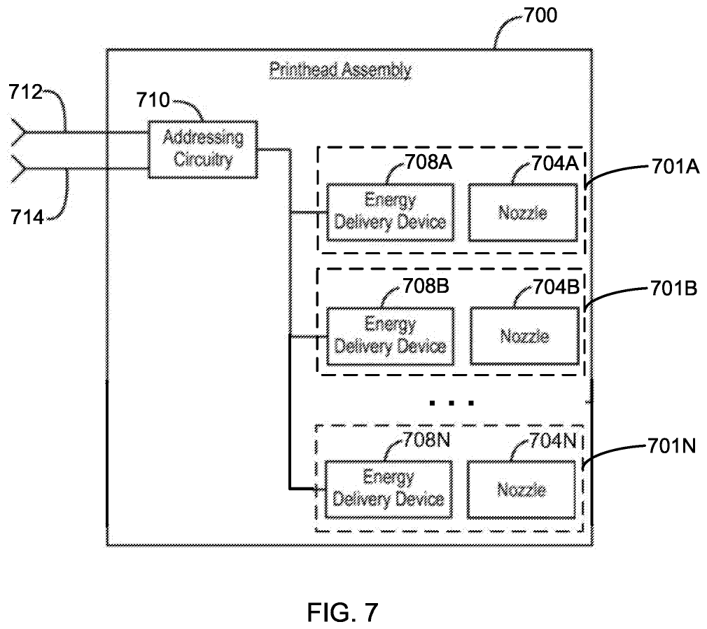

Each of the nozzles 404 may be part of separate and distinct fluid chambers (e.g., as described in more detail herein with respect to FIG. 7) that each include an energy delivery device 408 electrically coupled to an output of a drive transistor 410. Accordingly, when a given one of the drive transistors 410 receives a signal to activate, it provides a current pulse to a corresponding one of the energy delivery devices 408, thereby causing the corresponding one of the energy delivery devices 408 to generate heat. The heat generated by the corresponding energy delivery device 408 causes ink to be ejected from a corresponding one of the nozzles 404 and onto a print medium. In some examples, the current pulse can be sent from the drive transistors 410 to the energy delivery devices 408 in a series of pulses. The energy delivery device 408 can be a resistor, piezoelectric material that deforms in response to an applied voltage, a paddle made of a multi-layer thinfilm stack that deforms in response to a temperature gradient, etc., and the drive transistors can be any suitable type of transistors, including Field Effect Transistors (FETs), and others.

The fluid ejection dies 400 can include any suitable number of nozzles 404 and nozzle columns 406. The fluid ejection die 400 can include N nozzles 404, where N is an integer number that is two or greater. Although two nozzle columns 406 are show in FIGS. 4A and 4B that is not meant to be limiting. For example, the fluid ejection dies 400 can include additional ink feed slots 402 having corresponding nozzle columns 406 on each side of each of the additional ink feed slots 402. In some examples, if the fluid ejection dies 400 include multiple ink feed slots 402, then each of the ink feed slots 402 can eject different types of ink, such as different color inks or different materials. In other examples, if the fluid ejection dies 400 include multiple ink feed slots 402, then each of the ink feed slots 402 can eject the same type of ink.

The nozzles 404 can be divided into groups that are referred to herein as primitives 412. Each of the primitives 412 can include any suitable number of nozzles 404. Although each of the primitives 412 shown in FIGS. 4A and 4B include eight nozzles 404 (e.g., corresponding to “Address 0”, “Address 1”, “Address 2”, . . . , “Address 7”) that is not meant to be limiting. In other examples, each of the primitives 412 may include any desired amount of nozzles 404 per primitive 412 to exercise a desired level of control over the nozzles 404. The addresses corresponding to each of the nozzles 404 can be repeated for each of the primitives 412.

Moreover, the fluid ejection dies 400 in FIGS. 4A and 4B can operate in multiple modes. In some examples, a first mode of operation can be a high quality mode and a second mode of operation can be a high speed mode. This multi-mode operation of the fluid ejection dies 400 can be controlled by addressing circuitry, e.g., as described in more detail herein with respect to FIGS. 6A and 6B. The addressing circuitry can receive control data from an electronic controller, such as electronic controller 222 of FIG. 2, and process the received control data. Each of the drive transistors 410 within a given primitive of the primitives 412 corresponds to a different, unique address within the given primitive. By processing the control data, the addressing circuitry can determine which of the drive transistors 410 to activate within a given one of the primitives 412.

Further, by processing the control data, the addressing circuitry can also determine a mode of operation, such as high quality mode or high speed mode, for each of the primitives 412. As used herein, the term “time slice” refers to a time period to process and execute a primitive control command, and can be based on various factors (e.g., control cycles, circuit complexity, pulse frequency, etc.). Moreover, as used herein, the term “print period” refers to a minimum time period to selectively fire all of the nozzles 404 for a given one of the primitives 412, and is comprised of multiple time slices. Further, the print period can vary based on a mode of operation (e.g., a high quality mode or a high speed mode) of the fluid ejection dies 400.

In the high quality mode, each of the nozzles 404 for a given one of the primitives 412 fire individually, such that one of the nozzles 404 within a given one of the primitives 412 fires during a given time slice. Referring specifically to FIG. 4A, the logic mapping for each of the primitives 412 in the high quality mode is illustrated by arrows 412A from, for example, “Address 0” to a corresponding one of the drive transistors 410, “Address 1” to a corresponding one of the drive transistors 410, “Address 2” to a corresponding one of the drive transistors 410, and so on. A print period for the primitives 412 of FIG. 4A may depend an amount of nozzles, N (N being a positive integer), for the primitive. For example, if a given one of the primitives 412 includes eight nozzles, like the fluid ejection die 400 of FIG. 4A, then the print period can be comprised of eight time slices (e.g., a time slice corresponding to each of the nozzles 404 in each of the primitives 412). It should be noted that the print period in the high quality mode can vary based on the amount of nozzles 404 per primitive 412.

In the high speed mode, multiple subsets of the nozzles 404 for a given one of the primitives 412 can fire simultaneously, such that each of the nozzles 404 of the subset fire during the same time slice. Each of the subsets of the nozzles 404 can include pairs, triplets, or subsets of other sizes. Further, in some examples, the subsets of the nozzles 404 are an adjacent pair of nozzles 404 (e.g., nozzles 404 associated with “Address 0” and “Address 1” in a given one of the primitives 412). Moreover, even in the high speed mode, some of the nozzles 404 in a given one of the primitives 412 can be fired individually, such that one of the nozzles 404 fires during a given time slice.

Referring specifically to FIG. 4B, the logic mapping for each of the primitives 412 in the high speed mode is illustrated by arrows 414A and 414B. Notably, if processed control data indicates that a nozzle 404 associated with an even address (e.g., “Address 0”, “Address 2”, and so on) is to be activated, then arrows 414A indicate that the drive transistor 410 associated with the corresponding even address will be activated for the given time slice. However, if processed control data indicates that a nozzle 404 associated with an odd address (e.g., “Address 1”, “Address 3”, and so on) is to be activated, then arrows 414B indicate that the drive transistors 410 associated with the corresponding odd address and an adjacent even address will be activated.

A print period for the primitives 412 of FIG. 4B may depend a number of nozzles, N (N being a positive integer), and a number of the subsets, m (m being a positive integer less than N), for the primitive. In some examples, the total number of nozzles 404 across all of subsets of nozzles 404 is equivalent to the total number of nozzles N. Put another way, the number of nozzles per subset m multiplied by a number of subsets per primitive equals the number of nozzles per primitive N. A print period in the high speed mode can vary based on a size of the subsets of nozzles 404.

For example, if a given one of the primitives 412 includes eight nozzles divided into four subsets of two nozzles 404 (e.g., a pair of adjacent nozzles), like the fluid ejection die 400 of FIG. 4B, then the print period can be comprised of as few as four time slices (e.g., a time slice for each of the subsets of the nozzles 404 of the primitives 412). As another example, if a given one of the primitives 412 includes eight nozzles divided into two subsets of four nozzles 404 (e.g., a quadruplet of adjacent nozzles), then the print period can be comprised of as few as two time slices. Accordingly, the print period associated with the high mode is a fraction of the print period associated with the high quality mode. In some examples, the print period in the high speed mode can be represented as a ratio of the total number of nozzles on a primitive to the number of subsets for the primitive.

The nozzles 404 of the fluid ejection dies 400 of FIGS. 4A and 4B are depicted as low drop weight (“LDW”) nozzles having uniform bore sizes, as opposed to high drop weight nozzles (“HDW”). LDW nozzles have smaller bores, firing chambers, and heating elements, and may have different parameters for firing the LDW nozzles as compared to HDW nozzles, and, as a result, eject less fluid (e.g., ink) out of each individual nozzle when compared to HDW nozzles. However, in some examples, when a pair of adjacent nozzles 404 fire in the high speed mode, the fluid (e.g., ink) from the adjacent nozzles 404 can merge midair prior to contacting any print medium or, in some other examples, can merge upon contacting the print medium, thereby simulating ink being ejected from a single HDW nozzle. Accordingly, by using LDW nozzles that can simulate HDW nozzles and switch between various modes of operation, more nozzles 404 can be included on the fluid ejection dies 400, and ink efficiency and image quality can be improved. As described in more detail herein (e.g., with respect to FIG. 7), each of the nozzles 404 (and a corresponding energy delivery device 408 and drive transistor 410) can be located within separate and distinct fluid chambers on the fluid ejection dies 400.

It will be appreciated that the fluid ejection dies 400 of FIGS. 4A and 4B are examples of a fluid ejection dies that can be manufactured in accordance with the techniques described herein and that several variations may be possible within the scope of the claims. Moreover, the fluid ejection dies described herein can be used in 2D printing, 3D printing, and other applications besides printing, such as digital titration, among others.

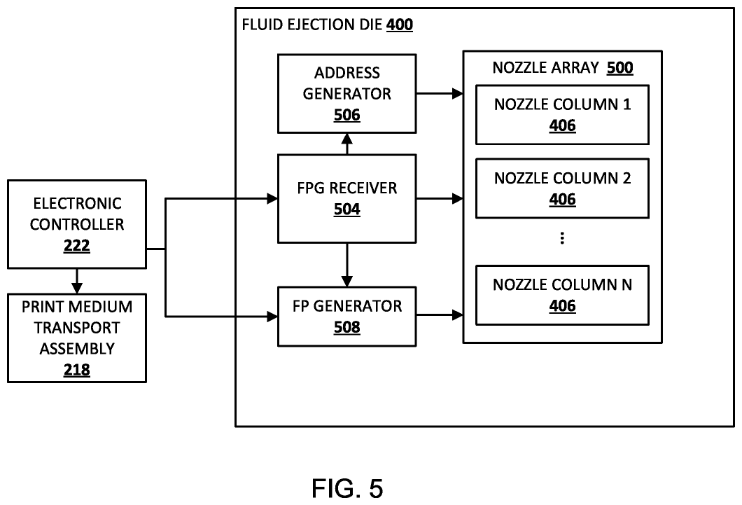

FIG. 5 is a block diagram of an example of drive circuitry that can be used to control fluid ejection dies, such as fluid ejection dies 400 of FIGS. 4A and 4B. The fluid ejection die 400 of FIG. 5 includes nozzle columns 406, which are shown as part of a nozzle array 500. The fluid ejection die 400 may be electronically coupled (e.g., via control lines 228) to an electronic controller (e.g., the electronic controller 222 of FIG. 2), and may receive print commands from the electronic controller. Print commands may be sent from the electronic controller to the fluid ejection die 400 in the form of a data packet referred to herein as a Fire Pulse Group (“FPG”). The FPG may be received on the fluid ejection die 400 by a controller, such as FPG receiver 504. A FPG can include FPG start bits, which are used by the fluid ejection die 400 to recognize the start of a FPG, and can also include FPG stop bits, which indicate the end of data packet transmission.

The FPG can also include a set of address bits for each nozzle column 406, each of the primitives 412 in each nozzle column 406, or a subset of the primitives 412 in each nozzle column 406. The address supplied to a primitive partly determines which drive transistor(s) within a primitive are activated, thereby resulting in fluid ejection at a corresponding nozzle(s). In some examples, the address bits are included in the FPG, and the FPG receiver 504 can send the address bits to the appropriate nozzle columns 406. In other examples, the address bits are not included in the FPG, and the FPG receiver 504 can send the addressing data to an address generator 506. In some of those other examples, the address generator 506 can generate the address bits and send the generated address bits to the appropriate nozzle columns 406. In some examples, all primitives (e.g., primitives 412 of FIGS. 4A and 4B) within a given one of the nozzle columns 406 can use the same addressing data. In other examples, each of the primitives (e.g., primitives 412 of FIGS. 4A and 4B) within a given one of the nozzle columns 406 can use different addressing data.

The FPG can also include bit(s) of firing data for each of the primitives 412 (e.g., primitives 412 of FIGS. 4A and 4B), and is referred to herein as primitive data. The primitive data is used to generate primitive fluid ejection commands that are sent from the FPG receiver 504 to each primitive of the primitives 412. The primitive data can be used to determine whether the nozzle that is identified by the address bits within a given primitive of the primitives 412 is activated. The primitive data may be different for each of the primitives 412. The specific use of this firing data and primitive data is disclosed in more detail herein (e.g., with respect to FIGS. 6A and 6B).

In some examples, the FPG can further include pulse data, which controls the characteristics of the current pulse sent to the energy delivery devices 408. The characteristics of the current pulse sent to the energy delivery devices can include pulse width, a number of pulses, duty cycle, and the like. In some of those examples, the FPG can sent the pulse data to a fire pulse (“FP”) generator 508. In some other examples, the FP generator 508 can receive the pulse data directly from an electronic controller (e.g., electronic controller 222 of FIG. 2). The FP generator 508 can generate a firing signal based on the pulse data and deliver the firing signal to the nozzle columns 406. Once the FPG has been loaded, the FP generator 508 can send the firing signal to the nozzle columns 406, thereby causing the addressed nozzles to be activated and eject ink. Nozzle(s) 404 within a primitive 412 may be activated when the primitive data loaded into that primitive indicates firing should occur, the address(es) conveyed to the primitive match nozzle address(es) in the primitive, and a fire signal is received by the primitive. The circuitry than can be used to implement this process is described in more detail herein (e.g., with respect to FIGS. 6A and 6B).

In some examples, the FPG can also include data (e.g., a control bit) that indicates whether drive transistors 410 are to be activated according to a particular mode (e.g., a high quality mode or a high speed mode). In some other examples, the address generator 506 can receive the data directly from an electronic controller (e.g., electronic controller 222 of FIG. 2) to control a mode of the fluid ejection die 400. In high quality mode, one of the drive transistors 410 associated with a given nozzle 404 is activated at a given time slice. In high speed mode, multiple drive transistors 410 associated with a subset of nozzles 404 are activated at the same time slice. Additional modes are also possible that can be implemented by addressing circuitry (e.g., as described herein with respect to FIGS. 6A and 6B). Further, the addressing circuitry can use the FPG and other data (e.g., control bit) to generate primitive commands used to indicate which of the nozzles 404 should be fired.

In some examples, when the electronic controller 222 sends print commands to the fluid ejection die 400, the electronic controller 222 can send print commands to print medium transport assembly 218. The print commands send to the print medium transport assembly 218 can vary based on a mode of operation (e.g., a high quality mode or a high speed mode). For example, in the high quality mode, the priority may be print quality over print speed, so the print medium transport assembly 218 can feed (or displace) a print medium across the fluid ejection die 400 at a slower rate to ensure proper quality. As another example, in the high speed mode, the priority may be print speed over print quality, so the print medium transport assembly 218 can feed a print medium across the fluid ejection die 400 at a faster rate to ensure adequate speed. However, the fluid ejection die 400 disclosed herein may dynamically switch between multiple modes and account for these different rates for feeding the print medium across the fluid ejection die 400.

It will be appreciated that the block diagram of FIG. 5 is one example of fluid ejection dies 400 that can be manufactured in accordance with the techniques described herein and that several variations may be possible within the scope of the claims. For example, various components of the fluid ejection dies 400, such as the address generator 506 and the FP generator 508, may be separate from the fluid ejection dies 400. Furthermore, the fluid ejection dies can be used in any suitable type of precision dispensing device, include a 2D printer, a 3D printer, a digital titration device, etc. Examples of 2D printing technology include thermal ink jet (TIJ) technology, piezoelectric ink jet technology, etc.

FIGS. 6A and 6B are schematic diagrams showing an example of an addressing circuit 600 that can implement multi-mode activation of fluid ejection dies 400 (e.g., fluid ejection dies 400 of FIGS. 4A and 4B). Multi-mode activation includes dynamically activating the fluid ejection dies 400, throughout a print cycle, in either a high quality mode or a high speed mode. Although FIGS. 6A and 6B are discussed in connection with particular configurations of logic gates (e.g., two inverters 602 and a NAND gate 604 in FIG. 6A, and various sets of AND gates 612, 614, and 620 in FIG. 6B) that is not meant to be limiting. It should be readily apparent that various other configurations and combinations of logic gates can be utilized, and that the configurations and combinations are disclosed herein for illustrative purposes. In some examples, a given configuration of logic gates to implement the techniques disclosed herein may depend on an area of a fluid ejection die that the addressing circuit 600 is disposed on or otherwise embedded therein.

In particular, FIG. 6A shows a portion of the addressing circuit 600 that can implement multi-mode activation. The multiple modes can include a first mode, such as a high quality mode, and a second mode, such as a high speed mode. The addressing circuit 600 may be fabricated in a semiconductor layer, which can include drive transistors 410 (e.g., the drive transistors 410 of FIGS. 4A and 4B), and various logic components (e.g., Boolean logic gates) for controlling the firing of the drive transistors 410. The portion of the addressing circuit 600 shown in FIG. 6A includes two inverters 602 and a NAND gate 604. The addressing circuit 600 also includes an address input 606, a mode input 608, a non-inverted output 610, and an inverted output 611. The address input 606 receives address bits (e.g., Addr[0], Addr[1], and Addr[2]) from, for example, the FPG receiver 504 or the address generator 506 of FIG. 5. The mode input 608, Dual_Cntl_n (e.g., a control bit), indicates whether the drive transistors 410 are to be activated using the high quality mode or the high speed mode. The mode input 608 can also be received from the FPG receiver 504.

The non-inverted output 610 outputs the non-inverted version of the address bits received at the address input 606. In high quality mode, the inverted output 611 outputs the inverted version of the address bits received at the input 606. More specifically, the outputs nAddr_Dual[1] and nAddr_Dual[2] are inverted regardless of the status of Dual_Cntl_n, and the output nAddr_Dual[0] is inverted if Dual_Cntl_n equals one, which indicates operation in high quality mode. Thus, if Dual_Cntl_n equals one (e.g., first logic state, which indicates operation in high quality mode), the addressing circuit 600 is equivalent to an addressing circuit in which the NAND gate 604 is replaced by a simple inverter. However, if Dual_Cntl_n is equal to zero (e.g., second logic state, which indicates operation in high speed mode), the output nAddr_Dual[0] is equal to zero regardless of the value of Addr[0].

The inverted outputs 611 and non-inverted outputs 610 can be sent to the primitives 412 (e.g., primitives 412 of FIGS. 4A and 4B) of each nozzle column 406 (e.g., nozzle columns 406 of FIGS. 4A and 4B). Each of the primitives 412 include logic that uses the inverted outputs 611 and non-inverted output 610 to determine which of the drive transistors 410 are being addressed by the address bits and the operation mode (e.g., via control bit Dual_Cntl_n), as shown in FIG. 6B.

FIG. 6B shows another portion of the addressing circuit 600 that can implement multi-mode activation. The portion of the addressing circuit 600 shown in FIG. 6B is for a given one of the primitives 412 (e.g., primitives 412 of FIGS. 4A and 4B). The inverted outputs 611 and non-inverted outputs 610 are routed to a first set of AND gates 612. The output of each AND gate of the first set of AND gates 612 is referred to as an “address selection signal” and is a binary bit that indicates whether an associated nozzle is selected for activation.

The firing signal 616 and the primitive data 618 (e.g., as discussed in connection with FIG. 5) can be provided as input to a second set of AND gates 614. The address selection signal (e.g., the output of each AND gate of the first set of AND gates 612) and the output of the output of each AND gate of the second set of AND gates 614 are set to a third set of AND gates 620. The output of each AND gate of the third set of AND gates 620, Fire_FET[n], is coupled to a gate of one of the drive transistors 410. For example, with reference to FIGS. 4A and 4B, the output labeled Fire_FET[0] can control the drive transistor 410 at “Address 0” for a given one of the primitives 412, the output labeled Fire_FET[1] can control the drive transistor 410 at “Address 1” for a given one of the primitives 412, and so on.

In high quality mode, each unique combination of the address bits causes a single AND gate from the first set of AND gates 612 to output a first logic state (e.g., high or one). For example, in high quality mode, address bits [000] can activate a drive transistor associated with “Address 0”, address bits [001] can activate a drive transistor associated with “Address 1”, and so on. In high speed mode, some combinations of address bits will cause the output of a subset of AND gates from the first set of AND gates 612 to output a first logic state (e.g., high or one). For example, in high speed mode, address bits [000] can activate a drive transistor associated with “Address 0”, but address bits [001] can activate drive transistors associated with both “Address 0” and “Address 1”. The logic table for the addressing circuit 600 disclosed in FIGS. 6A and 6B is shown below in Table 1.

TABLE 1

| | | Address | | | Drive |
|---|---|---|---|---|---|
| | Dual_ | Sent to | | nAddr_ | Transistor |
| | Cntl_n | Primitive | Addr[2:0] | Dual[2:0] | Activated |
| HIGH | 0 | 0 | 000 | 111 | 0 |
| SPEED | 0 | 1 | 001 | 110 | 0 & 1 |
| MODE | 0 | 2 | 010 | 101 | 2 |
| | 0 | 3 | 011 | 100 | 2 & 3 |
| | 0 | 4 | 100 | 011 | 4 |
| | 0 | 5 | 101 | 010 | 4 & 5 |
| | 0 | 6 | 110 | 001 | 6 |
| | 0 | 7 | 111 | 000 | 6 & 7 |
| HIGH | 1 | 0 | 000 | 111 | 0 |
| QUALITY | 1 | 1 | 001 | 110 | 1 |
| MODE | 1 | 2 | 010 | 101 | 2 |
| | 1 | 3 | 011 | 100 | 3 |
| | 1 | 4 | 100 | 011 | 4 |
| | 1 | 5 | 101 | 010 | 5 |
| | 1 | 6 | 110 | 001 | 6 |
| | 1 | 7 | 111 | 000 | 7 |

From Table 1 above, when a state of Dual_Cntl_n has a first logic state (e.g., high or one), a fluid ejection die can operate in high quality mode such that each unique combination of address bits (e.g., Addr[2:0] in Table 1) will activate a single drive transistor. However, when the state of Dual-Cntl_n has a second logic value (e.g., low or zero), the fluid ejection die can operate in a high speed mode such that address bits for even addresses (e.g., “Address 0”, “Address 2”, etc.) will activate a single drive transistor, and such that address bits for odd addresses (e.g., “Address 1”, “Address 3”, etc.) will simultaneously activate multiple drive transistors.

For example, to energize an energy delivery device associated with “Address 0”, an electronic controller (e.g., electronic controller 222 of FIG. 2) can send address bits of [000] to primitive(s) (e.g., primitives 412 of FIGS. 4A and 4B). This causes a nozzle associated with “Address 0” to fire regardless of a state of Dual_Cntl_n (e.g., whether it is a first logic state or second logic state). As another example, to energize an energy delivery device associated with “Address 1”, an electronic controller (e.g., electronic controller 222 of FIG. 2) can send address bits of [001] to primitive(s) (e.g., primitives 412 of FIGS. 4A and 4B). If a state of Dual_Cntl_n is set to a first logic state (e.g., high quality mode), then a single nozzle associated with “Address 1” is fired. However, if the state of Dual_Cntl_n is set to a second logic state (e.g., high speed mode), then both a nozzle associated “Address 0” and a nozzle associated with “Address 1” are fired.

The values corresponding to Addr[2:0] and Dual_Cntl_n are referred herein as both print commands and primitive fluid ejection commands (or simply primitive commands), and can be processed using the addressing circuit 600 to determine a mode of operation for a fluid ejection die and determine which nozzles to fire for the primitive at any given time slice. These different modes and the operation of the nozzles in these different modes is described in more detail herein (e.g., with respect to FIGS. 4A and 4B). By processing these primitive commands, the addressing circuit 600 can dynamically switch between a high quality mode and a high speed mode. In some examples, this switching occurs between consecutive print periods. In other examples, this switching occurs between commands within a print period, thereby dynamically adjusting the duration of a print period after it has already started.

Moreover, this switching can be based on a desired application, such as indicated by input received from a user (e.g., via host 224 of FIG. 2) or a particular type of printing, such as 2D printing, 3D printing, and other applications besides printing, including digital titration, among others. Therefore, a fluid ejection system (e.g., ink jet printing system 200 of FIG. 2) can dynamically switch between a high quality mode and a high speed mode based on a state of a control bit (e.g., logic value of Dual_Cntl_n) and address bits sent to each of the primitives.

Moreover, it should also be noted that the implementations of FIGS. 6A and 6B are just one example of an addressing circuit that can be used for dynamically controlling the firing of nozzles. For example, and as noted above, the logic gates of FIGS. 6A and 6B are shown as inverters, NAND gates, and sets of AND gates. However, the logic gates can be any suitable combination of electronic devices that are capable of performing Boolean logic, such as AND gates, OR gates, inverters, flip-flops, and diodes, among others. It should be readily apparent that the logic table shown in Table 1 is based on the addressing circuit 600 of FIGS. 6A and 6B that is provided for illustrative purposes, and is not meant to be limiting. It should be appreciated that the addressing circuit 600 of FIGS. 6A and 6B can include additional components not depicted in FIGS. 6A and 6B, and that the high quality mode and high speed mode are merely possible applications of the functionality disclosed herein.

FIG. 7 is a simplified block diagram showing an example of a printhead assembly 700 that supports multi-mode activation of fluid ejection dies, such as fluid ejection dies 400 of FIGS. 4A and 4B. The printhead assembly 700 includes a plurality of separate and distinct fluid chambers 701A-701N. Each of the fluid chambers 701A-701N include a corresponding nozzle 704A-704N that is fluidically coupled to a corresponding energy delivery device 708A-708N. In some examples, each of the fluid chambers 701A-701N include a single corresponding energy delivery device 708A-708N, while in other examples, each of the fluid chambers 701A-701N include multiple corresponding energy delivery devices 708A-708N. The printhead assembly 700 also include addressing circuitry 710, which in some examples corresponds to addressing circuit 600 of FIGS. 6A and 6B. The addressing circuitry 710 can receive, e.g., from electronic controller 222 of FIG. 2, address bits 712 and an activation bit 714 as input. The address bits 712 indicate which of the nozzles 704A-704N are to be activated and the activation bit 714 indicates a mode of operation (e.g., high quality mode or high speed mode) for a given print period.

By providing separate and distinct fluid chambers 701A-701N, each of the nozzles 704A-704N can be fired individually and/or simultaneously with other nozzles. In some examples, each of the nozzles 704A-704N can be fired individually and sequentially (e.g., as in high quality mode), such that the print period associated with the printhead assembly 700 is N time slices, where N is an integer number equivalent to an amount of nozzles included on the printhead assembly 700. In other examples, some of the nozzles, such as nozzle 704A, can be fired individually, while other nozzles, such as nozzle 704B can be fired simultaneously with nozzle 704A (e.g., as in high speed mode), thereby reducing a number of time slices to fire each of the nozzles 704A-704N and reducing the print period. Further, because the printhead assembly 700 can dynamically switch between the high quality mode and the high speed mode, various print periods can be achieved for any desired application(s).

Accordingly, techniques described herein facilitate selective activation of a number of individual fluid ejection nozzles (e.g., all nozzles of a primitive) during a print period in a high quality mode, or subsets of the nozzles during a fraction of the print period in a high speed mode. By providing a fluid ejection die having LDW nozzles with uniform bores, a greater number of nozzles can be included on the fluid ejection die as compared to having HDW nozzles. This greater number of nozzles allows combined with the dynamic switching between operating modes results in improved ink efficiency and improved quality of characters, symbols, graphics, or other images printed on the print medium.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A fluid ejection die, comprising:
a primitive comprising a plurality of fluid ejection nozzles; and
an addressing circuit to selectively activate the primitive in a first mode or a second mode based on control data received from a fluid ejection system,
wherein, in the first mode, the addressing circuit is to activate, based on a single primitive fluid ejection command contained in the control data, an individual fluid ejection nozzle of the plurality of fluid ejection nozzles, and
wherein, in the second mode, the addressing circuit is to simultaneously activate, based on a single primitive fluid ejection command contained in the control data, multiple fluid ejection nozzles of the plurality of fluid ejection nozzles with separate fluid chambers.

2. The fluid ejection die of claim 1, wherein the addressing circuit of the fluid ejection die includes a plurality of logic gates to process the control data.

3. The fluid ejection die of claim 1, wherein the multiple nozzles of the plurality comprise a pair of fluid ejection nozzles.

4. The fluid ejection die of claim 1, wherein the multiple nozzles of the plurality of fluid ejection nozzles comprise a number of adjacent fluid ejection nozzles.

5. The fluid ejection die of claim 1, wherein the first mode is a high quality mode, wherein the second mode is a high speed mode, and wherein the addressing circuit is to detect a control bit within the control data and is to activate the primitive in the high quality mode or the high speed mode in response to detection of the control bit.

6. A fluid ejection die, comprising:
a primitive comprising a plurality of fluid ejection nozzles; and
an addressing circuit to selectively activate the primitive in a high quality mode or a high speed mode based on control data received from a fluid ejection system,
wherein, in the high quality mode, the addressing circuit is to selectively activate, based on the control data, each of the plurality of fluid ejection nozzles during a respective time slice of a first print period,
wherein, in the high speed mode, the addressing circuit is to selectively activate, based on the control data, each of a plurality of subsets of nozzles of the plurality of fluid ejection nozzles during a respective time slice of a second print period, wherein the second print period is shorter than the first print period.

7. The fluid ejection die of claim 6, wherein a ratio of the first print period to the second print period is equal to a ratio of a count of the plurality of fluid ejection nozzles of the primitive to a count of the plurality of subsets of nozzles of the plurality of fluid ejection nozzles of the primitive.

8. The fluid ejection die of claim 6, wherein in the high quality mode, the control data comprises a number of primitive fluid ejection commands that corresponds to a count of the fluid ejection nozzles of the primitive, and in the high speed mode, the control data comprises a number of primitive fluid ejection commands that corresponds to a count of the plurality of subsets of nozzles of the plurality of fluid ejection nozzles of the primitive.

9. The fluid ejection die of claim 6, wherein each of the plurality of subsets of nozzles of the plurality of fluid ejection nozzles comprises a pair of the fluid ejection nozzles.

10. The fluid ejection die of claim 6, wherein each of the plurality of subsets of nozzles of the plurality of fluid ejection nozzles comprises a number of adjacent fluid ejection nozzles with separate fluid chambers.

11. The fluid ejection die of claim 10, wherein each subset of adjacent fluid ejection nozzles eject fluid droplets that merge midair.

12. The fluid ejection die of claim 10, wherein each subset of adjacent fluid ejection nozzles eject fluid droplets that merge on a print medium.

13. The fluid ejection die of claim 6, wherein each the plurality of fluid ejection nozzles have uniform bore sizes.

14. A fluid ejection system, comprising:
a fluid ejection die including a primitive comprising N fluid ejection nozzles;
an addressing circuit to activate the primitive in a high quality mode or a high speed mode;
a print medium transport assembly to displace one of a print media and the fluid ejection die relative to the other; and
a controller that generates and provides control data and addressing data to the addressing circuit for processing, wherein the addressing circuit is to:
process the control data to detect a state of a control bit, and
process the addressing data to activate, based on the state of the control bit, each of the N fluid ejection nozzles or m subsets of the N fluid ejection nozzles, and
wherein the print medium transport assembly displaces the print media across the fluid ejection die at different rates based on the state of the control bit.

15. The fluid ejection system of claim 14, wherein, in the high quality mode, the addressing circuit is to process the control data to detect a number of single primitive fluid ejection commands that corresponds to the N fluid ejection nozzles of the primitive, and, in the high speed mode, the addressing circuit is to process the control data to detect a number of single primitive fluid ejection commands that corresponds to the m subsets of the N fluid ejection nozzles of the primitive.
